(19) United States
(12) Patent Application Publication
(10) Pub. No.: US 2012/0012575 A1
(43) Pub. Date: Jan. 19, 2012

(54) Radio Frequency Heating Fork

(75) Inventor: Francis Eugene Parsche, Palm Bay, FL (US)

(73) Assignee: HARRIS CORPORATION, Melbourne, FL (US)

(21) Appl. No.: 12/835,331

(22) Filed: Jul. 13, 2010

(51) Int. Cl. H05B 6/02

(52) U.S. Cl. 219/600

(57) ABSTRACT

An apparatus for heating a target comprises a radio frequency heating fork having two substantially parallel tines, the substantially parallel tines electrically connected at a loop end of the radio frequency heating fork, and the substantially parallel tines separated at an open end of the radio frequency heating fork, and a feed coupler connection, the feed coupler connection connecting a power source across the substantially parallel tines of the radio frequency heating fork. The application of power across the substantially parallel tines of the radio frequency heating fork results in induction heating near the loop end of the radio frequency heating fork, and dielectric heating near the open end of the radio frequency tuning fork. A target can be positioned relative to the heating fork to select the most efficient heating method. The heating fork can provide near fields at low frequencies for deep heat penetration.

### STATEMENT REGARDING FEDERALLY SPONSORED RESEARCH OR DEVELOPMENT

[Not Applicable]

### CROSS REFERENCE TO RELATED APPLICATIONS

[Not Applicable]

### BACKGROUND OF THE INVENTION

The present invention relates to radio frequency (“RF”) heating. In particular, the present invention relates to an advantageous and efficient apparatus and method for heating substances of varying conductivities.

RF heating can be used in a variety of applications. For example, oil well core samples can be heated using RF energy. These core samples, however, can vary greatly in conductivity, and therefore respond differently to various types of heating. Dielectric heating is efficient and preferable for samples having a low conductivity. Samples with higher conductivity are best heated by inductive heating. Medical diathermy, or the use of heat to destroy abnormal or unwanted cells, is another application that may utilize RF heating.

RF heating is a versatile process for suitable for many materials as different RF energies may be used. There can be electric fields E, magnetic fields H, and or electric currents I introduced by the RF heating applicator. Linear applicators, such as a straight wire dipole emphasize strong radial near E fields by divergence of current I. Circular applicators, such as a wire loop emphasize strong radial H fields by curl of current I. Hybrid applicator forms may include the helix and spiral to produce both strong E and H fields. Uninsulated RF heating applicators may act as electrodes to introduce electric currents I in the media.

Parallel linear conductors form an antenna in U.S. Pat. No. 2,283,914, entitled “Antenna” to P. S. Carter. Now widely known as the folded dipole antenna, the antenna uses equal direction current flows in the thin wires and a voltage summing action to bring the driving impedance to a higher value. The folded dipole antenna did not, however, include aspects of: antiparallel current flow (opposite current directions or senses), operation with open terminals at one end, induction coupling to a separate feed structure, or capacitor loading. The folded dipole antenna is useful for operation at sizes of about ½ wavelength and above.

U.S. Pat. No. 2,507,528 entitled “Antenna” to A. G. Kandoian describes antiparallel (equal but opposite direction) currents flowing on the opposite edges of a slot in a conductive plate. Horizontal polarization was realized from a vertically oriented slot.

RF heating may operate by near fields or far fields. Near fields are strong reactive energies that circulate near RF heating applicators. Far fields may comprise radio waves at a distance from the applicator. Both near and far fields are useful for RF heating, and many tradeoffs are possible. For instance, near fields may be more useful for low frequencies, when the applicator is small in size, and for conductive materials. Far fields may be preferred for heating at a distance and for heating low conductivity materials.

### SUMMARY OF THE INVENTION

The present radio frequency heating fork is useful for heating a variety of targets because the heat produced by the radio frequency heating fork includes induction heating and dielectric heating. A particular type of heating can be selected simply by positioning the target relative to the radio frequency heating fork.

The present radio frequency heating fork includes a method for heating a target using a radio frequency heating fork, the radio frequency heating fork comprising two substantially parallel tines, the substantially parallel tines electrically connected at a loop end of the radio frequency heating fork, and the substantially parallel tines separated at an open end of the radio frequency heating fork, and a feed coupler connection, the feed coupler connection connecting a power source across the substantially parallel tines of the radio frequency heating fork, the method comprising: positioning a target relative to a radio frequency heating fork; and heating the target by applying power across the radio frequency heating fork using a feed coupler connection.

The positioning of the target may further comprise relatively positioning the target between the substantially parallel tines of the radio frequency heating fork. The positioning of the target may further comprise relatively positioning the target on or between the substantially parallel tines of the radio frequency heating fork, and near the loop end of the radio frequency heating fork, where the heating of the target is primarily due to induction heating. Alternatively, the positioning of the target may further comprise relatively positioning the target on or between the substantially parallel tines of the radio frequency heating fork, and near the open end of the radio frequency heating fork, where the heating of the target is primarily due to dielectric heating.

The feed coupler connection may be inductively connected to the substantially parallel tines of the radio frequency heating fork near the loop end of the radio frequency heating fork. Alternatively, the feed coupler connection may be electrically connected to the substantially parallel tines of the radio frequency heating fork near the loop end of the radio frequency heating fork. The induction feed coupler connection may include a Balun. Furthermore, the frequency radio frequency heating fork may be tuned using a capacitor placed across the substantially parallel tines of the radio frequency heating fork.

The present radio frequency heating fork includes an apparatus for radio frequency heating of a target, the apparatus comprising: a radio frequency heating fork, the radio frequency heating fork having two substantially parallel tines, the substantially parallel tines electrically connected at a loop end of the radio frequency heating fork, and the substantially parallel tines separated at an open end of the radio frequency heating fork, and a feed coupler connection, the feed coupler connection connecting a power source across the substantially parallel tines of the radio frequency heating fork. The application of power across the substantially parallel tines of the radio frequency heating fork results in induction heating near the loop end of the radio frequency heating fork, and dielectric heating near the open end of the radio frequency tuning fork.

The feed coupler connection may be inductively connected to the substantially parallel tines of the radio frequency heating fork near the loop end of the radio frequency heating fork. The induction feed coupler connection may include a Balun. Alternatively, the feed coupler connection may be electrically connected to the substantially parallel tines of the radio frequency heating fork near the loop end of the radio frequency heating fork. A capacitor may also be connected between the substantially parallel tines of the radio frequency heating fork.

Other aspects of the invention will be apparent to one of ordinary skill in the art in view of this disclosure.

### BRIEF DESCRIPTION OF THE DRAWINGS

FIG. 1 depicts the present radio frequency heating fork employing a wireless connection.

FIG. 2 depicts the present radio frequency heating fork employing a hard-wired connection.

FIG. 3 depicts the heating pattern for the radio frequency heating fork with a target.

### DETAILED DESCRIPTION OF THE PREFERRED EMBODIMENTS

The subject matter of this disclosure will now be described more fully, and one or more embodiments of the invention are shown. This invention may, however, be embodied in many different forms and should not be construed as limited to the embodiments set forth herein. Rather, these embodiments are examples of the invention, which has the full scope indicated by the language of the claims.

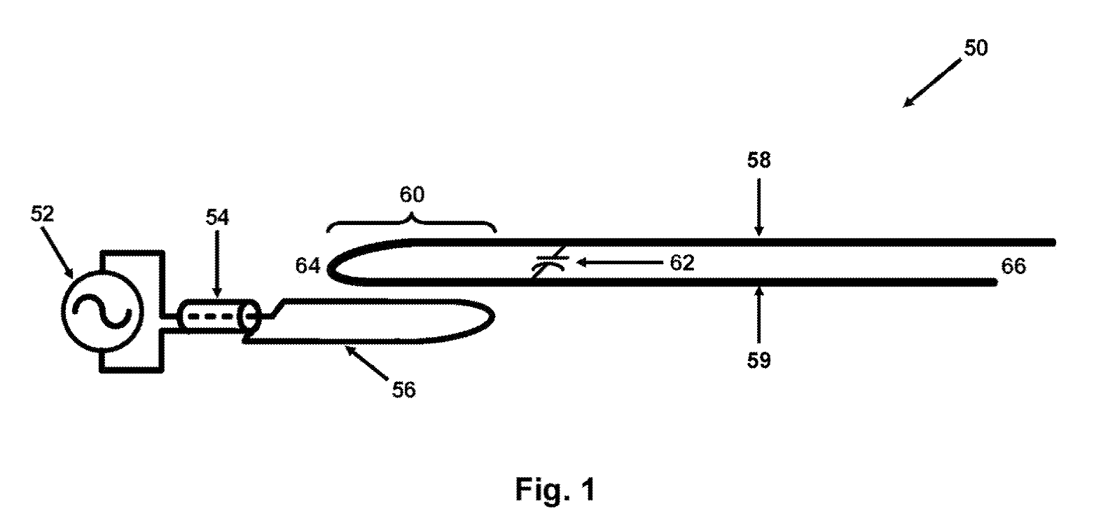

In FIG. 1, a radio frequency heating fork 50 includes tines 58 and 59, and incorporates a wireless, induction feed coupler connection. A coaxial feed 54 is connected at one end to AC power supply 52, and at the other end to supply loop 56. The supply loop 56 and the loop end 64 of the heating fork 50 are positioned near each other and overlap, which creates a transformer effect that transfers energy from the supply loop 56 to the heating fork 50. The induction feed coupler may be adjusted for a fifty Ohm drive resistance or as desired. The amount of overlap and the distance between supply loop 56 and loop end 64 of heating fork 50 can be varied, which in turn varies the resistance and heating. Tines 58 and 59 are electrically connected through loop end 64. Insulation may be placed over the outside or the heating fork 50 as may be desirable for internal medical diathermy applications.

Heating fork 50 may be optionally equipped with capacitor 62 for tuning purposes. Heating fork 50 naturally operates at a frequency of approximately one-quarter of a wavelength. Optional capacitor 62 can reduce this frequency to, for example, one-twentieth or one-thirtieth of a wavelength. RF shielding (not shown), such as a metal box, may be used over the heating for 50 to control radiation. Supply loop 56 advantageously functions as an isolation transformer or Balun which serves as a common mode choke for stray current suppression on the surface of coaxial feed 54. Although not shown, heating fork 50 may be immersed or otherwise positioned inside a target media to be RF heated.

The length L of heating fork 50 is preferentially one-quarter of a wavelength at the operating frequency, although L may be made shortened as desired adding or increasing the capacitance of capacitor 62. High voltages and high currents are thus easily produced by the heating fork as the hyperbolic tangent function asymptotically approaches zero and infinity through one-quarter of a wavelength, e.g. 90 electrical degrees.

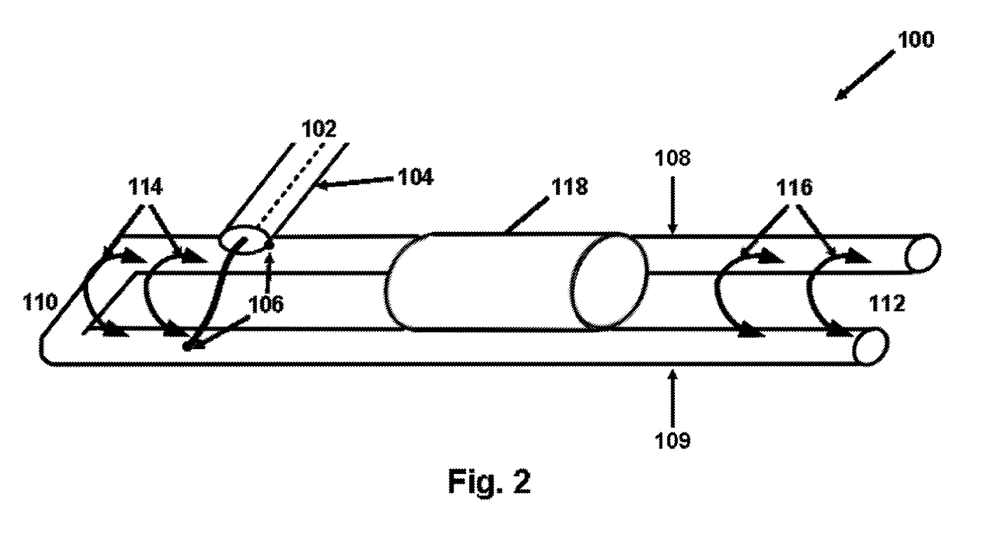

Turning now to FIG. 2, radio frequency heating fork 100 includes tines 108 and 109, and incorporates a hardwired feed coupler connection. Coaxial feed 104 is connected at one end to an AC power supply (not shown), and connected at the other end to heating fork 100 at feed coupler connections 106 near loop end 110 of heating fork 100. Tines 108 and 109 are electrically connected through loop end 110. When power is applied across heating fork 100, a strong magnetic field 114 is formed near loop end 110 of heating fork 100. Conversely, a strong electric field 116 is formed near open end 112 of heating fork 100. These fields are similarly formed when power is applied to heating fork 50 in FIG. 1 (not shown).

The two different fields provide two different heating qualities. The strong magnetic field 114 formed near loop end 110 of heating fork 100 provides induction heating, which is excellent for heating conductive substances. The strong electric field 116 formed near open end 112 of heating fork 100, on the other hand, is excellent for heating less conductive, or even non-conductive substances. By positioning target 118 relative to heating fork 100, the most advantageous form of heating can be used depending on the conductivity of target 118. For example, a target 118 having a high conductivity may be positioned closer to loop end 110 of heating fork 100. On the other hand, even a target comprised of distilled water can be heated near the open end of heating fork 100 due to the strong electric field in that area. More even heating may be achieved if target 100 is positioned between tines 108 and 109 of heating fork 100.

The present radio frequency heating fork has a low voltage standing wave ratio (“VSWR”) when operated in an appropriate frequency range. For example, in one embodiment the VSWR approached 1:1 when the radio frequency heating fork was operated at approximately 27 MHz.

Heating fork tines 58, 59, 108 and 109 need not be cylindrical in cross section, and other shapes may be desirable for specific applications. For instance, if used for internal medical diathermy, the fork tines may have a C-shaped cross section to facilitate tissue penetration for positioning the heating fork relative to the target cells.

Heating forks 50 and 100 are conductive structures, typically comprised of a metal, having a differential mode electric current distribution with equal current amplitudes on each tine, with currents flowing in opposite directions on each tine. For example, when the AC power supply waveform is sinusoidal the current distribution along heating fork 50 of FIG. 1 is sinusoidal such that maximum amplitude occurs at the loop end 68, and a minimum at the open end 68. The voltage potential across fork tines 58 and 59 is at a minimum at loop end 64 and at a maximum at the open end 66. The ratio of the voltage E between the tines to the current I along the tines line is the impedance Z is given by:

Z_{L}=γL

Where:
Z_{L}=the impedance along the length of the tines
γ=the complex propagation constant gamma along the fork (including an attenuation constant α and a phase propagation constant β)
L=the overall length of the heating fork from the loop end 64 to the open end 66

Continuing the theory of operation with reference to FIG. 1, supply loop 56 conveys an electric current I in a curl causing a magnetic field B (not shown). Loop end 64 of heating fork 50 overlaps the magnetic field B of supply loop 56 causing a sympathetic electric current I flow into heating fork 50. Thus supply loop 56 and loop end 64 essentially form the “windings” of a transformer in region 60. Bringing supply loop 56 closer to loop end 64 provides a greater load resistance to AC power supply 52, while moving supply loop 56 further from loop end 64 provides less load resistance to AC supply 52. The frequency of resonance of heating fork 50 becomes slightly less as supply loop 56 is brought near loop end 64.

The fields generated by heating forks 50 and 100 are now considered. Although skeletal in form, the heating fork structure relates to linear slot antennas, and heating forks 50 and 100 generate three reactive near fields, three middle fields, and two radiated far fields (E and H). The present radio frequency heating forks primarily utilize near-field heating. Without a heating load, the near fields may be described as follows:

H_{z}=−jE₀/2πη[(e^{-jkr1}/r₁)+(e^{-jkr2}/r₂)]

H_{ρ}=−jE₀/2πη[(z−λ/4)/ρ)(e^{-jkr1}/r₁)+(z−λ/4)/ρ)(e^{-jkr2}/r₂)]

E_{φ}=−jE₀/2π[(e^{-jkr1})+(e^{-jkr2})]

Where:
p, φ, z are the coordinates of a cylindrical coordinate system in which the slot is coincident with the Z axis
r₁ and r₂ are the distances from the heating fork to the point of observation
η=the impedance of free space=120π
E=the electric field strength in volts per meter
H=the magnetic field strength in amperes per meter

There are strong near E fields broadside to the plane of heating forks 50 and 100 during the heating process. The near H fields are strong broadside to the plane of heating fork 50 and 100, and in between tines 58 and 59 or 108 and 109 as well.

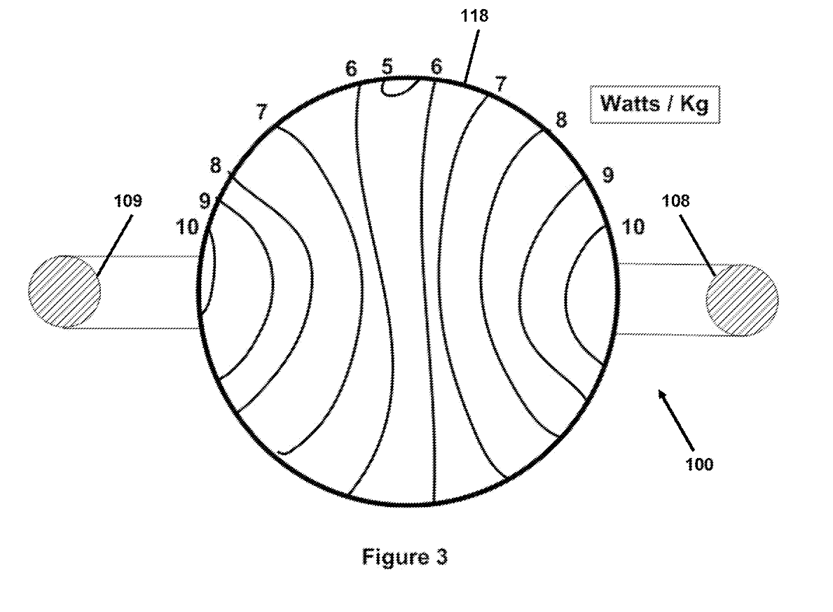

The placement of target 118 (see FIG. 2) may significantly modify near field phase and amplitude contours from those present during free space operation, and the derivation of the near field contours involving target 118 may be best accomplished by numerical electromagnetic methods. FIG. 3 is a profile cut contour plot of the specific absorption rate of heat in watts per kilogram for target 118 being heated by heating fork 100, with tines 108 and 109 on either side of target 118. The FIG. 3 plot was obtained by a method-of-moments analysis. The asymmetry seen is due to meshing granularity and would not be present in symmetric physical embodiments. As can be appreciated, the circular magnetic near fields from each of the antenna fork conductors add constructively in phase as the heating effect is nonzero in the target center. Exemplary operating parameters associated with FIG. 3 are listed in Table 1 below:

TABLE 1

| | |
|---|---|
| Application | Near field RF heating |
| Heating fork RF feed | Supply loop |
| Target material | Rich Athabasca oil sand, 15% bitumen |
| Target size | 10.2 cm diameter cylinder, 0.91 meters long |
| Target permittivity | 5 farads/meter |
| Target conductivity | 0.0017 mhos/meter |
| Target water content | 1.1% |
| Frequency | 6.78 MHz |
| Supply loop length | 1.05 meter |
| Supply loop width | 15.2 cm (same as heating fork) |
| Supply loop spacing from | 0.190 m center to center |
| heating fork | |
| Transmitter power | 1 kilowatt RMS |
| VSWR | Under 2.0 to 1 |
| Heating fork length | 3.1 meters |
| Spacing between fork | 15.2 cm |
| conductors | |
| Fork conductor diameter | 2.28 cm |
| Capacitor location | 1.33 meters from loop end |
| Capacitor capacitance | 317 pf |
| SAR rate in target | 5-10 watts/kilogram |
| H field amplitude in target | 0.1 to 0.4 amperes/meter |
| E field amplitude in target | ~8 kilovolts/meter |

The present radio frequency heating fork has been tested and found effective for the heating of petroleum ores, such as Athabasca oil sand in dielectric pipes. Referring to FIG. 2, in a large scale application heating fork tines 108 and 109 may comprise hollow metallic pipes to permit the withdrawal of radio frequency heated materials such as hydrocarbon ores or heavy oil, e.g. heating fork tines 108 and 109 may be comprised of solid wall or perforated wall well piping.

Frequency and electrical load management for the present radio frequency heating fork will now be discussed in reference to FIGS. 1 and 2. It may be preferred that heating fork 100 be operated at resonance for impedance matching and low VSWR to AC power source 102. Two methods for such operation involve variable frequency and fixed frequency operation. In the variable frequency method, AC power supply 102 is changed in frequency during heating to track the dielectric constant changes of target 118. This may be accomplished, for example, with a control system or by configuring AC power source as a power oscillator with heating fork 100 as the oscillator tank circuit. A second loop similar to supply loop 56 (see FIG. 1) may be used as tickler to drive the oscillator.

In a fixed frequency method, AC power source 52 may be held constant in frequency by crystal control, and the value of capacitor 62 varied to force a constant frequency of resonance from heating fork 50. The fixed frequency approach may be preferred if it is desired to avoid the need for shielding from excess RF radiation. For example, the fixed frequency approach may avoid the need for shielding by use of a RF heating frequency allocation. In the United States this may be in an Industrial, Scientific and Medical (ISM) band, e.g., at 6.78 Mhz, 13.56 Mhz, and other frequencies.

It is preferential to space tine 58 from tine 59 of RF heating fork 50, and tine 108 from tine 109 of RF heating fork 100, by about 3 or more tine diameters to avoid conductor proximity effect losses between the tines. Conductor proximity effect is a nonuniform current distribution that can occur with closely spaced conductors that increases loss resistance. Litz conductors may be useful with the present invention in low frequency embodiment of the present invention, say below about 1 MHz. The RF heating forks 50 and 100 may be operated in a vacuum or dielectric gas atmosphere such as sulfur hexafluoride (SF₆) to control corona discharges from open ends 66 and 112 at very high power levels. When uninsulated and in contact with a target media 118 that is conductive, heating forks 50 and 100 apply electric currents directly into the target media. Open ends 66 and 112 can function as electrodes if so configured.

Target 118 may comprise a heating puck, a dielectric pipe, or even a human patient undergoing a medical treatment. A method of the present invention is to place RF heating susceptors in the RF heating target for increased heating speed, or for selectively heating a specific region of the target. A RF heating susceptor is a material that heats preferentially in the presence of RF energies, such as, for example, graphite, titanates, ferrite powder, or even saltwater.

The present RF heating fork may also be useful for generating far fields and as an antenna when RF heating targets are not used. The orientation of the radiated far electric field is opposite that of heating fork orientation, e.g. a horizontally oriented heating fork produces a vertical polarized wave. The present RF heating forks are therefore useful for both near and far field heating, and for communications.

The present RF heating fork has multiple applications as a tool for RF heating, such as food and material processing, component separation and upgrading hydrocarbon ores, heat sealing and welding, and medical diathermy. The present RF heating fork may be operated at low frequencies for sufficient penetration, and by near fields for controlled radiation, thereby providing a selection of energy types E, H, and I.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged either in whole or in part. Therefore, the spirit and scope of the appended claims should not be limited to the description of the preferred versions contained herein.

1. A method for heating a target using a radio frequency heating fork, the radio frequency heating fork comprising two substantially parallel tines, the substantially parallel tines electrically connected at a loop end of the radio frequency heating fork, and the substantially parallel tines separated at an open end of the radio frequency heating fork, and a feed coupler connection, the feed coupler connection connecting a power source across the substantially parallel tines of the radio frequency heating fork, the method comprising:
positioning a target relative to a radio frequency heating fork; and
heating the target by applying power across the radio frequency heating fork using a feed coupler connection.

2. The method of claim 1, wherein the positioning of the target further comprises relatively positioning the target between the substantially parallel tines of the radio frequency heating fork.

3. The method of claim 1, wherein the positioning of the target further comprises relatively positioning the target on or between the substantially parallel tines of the radio frequency heating fork, and between the loop end of the radio frequency heating fork where the heating of the target is primarily due to induction heating, and the open end of the radio frequency heating fork where the heating of the target is primarily due to dielectric heating.

4. The method of claim 1, wherein the feed coupler connection is inductively connected to the substantially parallel tines of the radio frequency heating fork near the loop end of the radio frequency heating fork.

5. The method of claim 1, wherein the feed coupler connection is electrically connected to the substantially parallel tines of the radio frequency heating fork near the loop end of the radio frequency heating fork.

6. The method of claim 5, wherein the induction feed coupler connection includes a Balun.

7. The method of claim 1, further comprising tuning the frequency of the radio frequency heating fork using a capacitor placed across the substantially parallel tines of the radio frequency heating fork.

8. The method of claim 1, wherein the RF heating fork is immersed or placed inside the material to be heated.

9. An apparatus for radio frequency heating of a target, the apparatus comprising:
a radio frequency heating fork, the radio frequency heating fork having two substantially parallel tines, the substantially parallel tines electrically connected at a loop end of the radio frequency heating fork, and the substantially parallel tines separated at an open end of the radio frequency heating fork; and
a feed coupler connection, the feed coupler connection connecting a power source across the substantially parallel tines of the radio frequency heating fork.

10. The apparatus of claim 9, wherein the application of power across the substantially parallel tines of the radio frequency heating fork results in induction heating near the loop end of the radio frequency heating fork, and dielectric heating near the open end of the radio frequency tuning fork.

11. The apparatus of claim 9, wherein the feed coupler connection is inductively connected to the substantially parallel tines of the radio frequency heating fork near the loop end of the radio frequency heating fork.

12. The apparatus of claim 11, wherein the induction feed coupler connection includes a Balun.

13. The apparatus of claim 9, wherein the feed coupler connection is electrically connected to the substantially parallel tines of the radio frequency heating fork near the loop end of the radio frequency heating fork.

14. The apparatus of claim 9, further comprising a capacitor, the capacitor connected between the substantially parallel tines of the radio frequency heating fork.
